(19) United States
(12) Patent Application Publication
(10) Pub. No.: US 2026/0138625 A1
(43) Pub. Date: May 21, 2026

(54) MANAGEMENT SYSTEM AND METHOD FOR ELECTRONIC CONTROL UNIT IN VEHICLE

(71) Applicants: Hyundai Motor Company, Seoul (KR); Kia Corporation, Seoul (KR)

(72) Inventor: Soon Il Bang, Hwaseong-Si, Gyeonggi-Do (KR)

(21) Appl. No.: 19/228,892

(22) Filed: Jun. 5, 2025

(30) Foreign Application Priority Data
Nov. 18, 2024 (KR) 10-2024-0164268

(51) Int. Cl. B60W 50/029; B60W 50/02; G06F 8/65

(52) U.S. Cl. CPC B60W 50/029; B60W 50/0205; G06F 8/65; B60W 2050/021; B60W 2556/45

(57) ABSTRACT

A system may comprise an apparatus configured to generate current pattern data based on a transition of a network to a wake-up mode and based on a monitored current consumption amount of a battery over time, wherein the network is connected to at least one of a plurality of electronic control circuits, and wherein the battery supplies power to the network, and a server configured to receive, from the vehicle, the current pattern data, determine whether an error has occurred in an electronic control circuit by comparing the current pattern data with reference data, and, based on the determination, send a control signal to the vehicle for normalizing functions of the electronic control circuit.

### CROSS-REFERENCE TO RELATED APPLICATION

The present application claims the benefit of priority to Korean Patent Application No. 10-2024-0164268, filed in the Korean Intellectual Property Office on Nov. 18, 2024, the entire contents of which are incorporated herein by reference for all purposes.

### TECHNICAL FIELD

The present disclosure relates to management system and method for an electronic control unit in a vehicle.

### BACKGROUND

The matters described in this Background section are only for enhancement of understanding of the background of the disclosure, and should not be taken as acknowledgment that they correspond to prior art already known to those skilled in the art.

A vehicle may provide a plurality of electronic control units (ECU) or electronic control circuits to control operation devices for operation and various electrical devices for safety and convenience of a passenger.

The plurality of ECUs installed in a vehicle may perform network management to efficiently manage a vehicle power source by sending and receiving network management messages among the plurality of ECUs. The network management refers to a process in which an ECI enters a sleep mode when network communication is unnecessary, thereby minimizing or reducing power consumption across the plurality of ECUs connected to the network. Conversely, when network communication becomes necessary, the ECU wakes up and transition to a normal operating mode.

As a number of functions provided in vehicles continues to grow, a number of ECUs also increases rapidly. Consequently, ongoing research is being conducted on vehicle network management technologies that enable efficient power source management within such vehicles.

### SUMMARY

An object of an example of the present specification is to provide management system and method for an electronic control unit in a vehicle that can prevent occurrence of unnecessary current consumption due to an abnormal wake-up action of an ECU.

Technical objects that the present specification is to achieve are not limited to the technical objects that are mentioned above, and other technical objects that are not mentioned will be clearly understood by a person skilled in the art in the technical field to which the present disclosure belongs.

According to the present disclosure, a system may comprise, an apparatus, configured to, generate current pattern data, based on a transition of a network to a wake-up mode and based on a monitored current consumption amount of a battery over time, wherein the network is connected to at least one of a plurality of electronic control circuits, and wherein the battery supplies power to the network, and a server configured to, receive, from the vehicle, the current pattern data, determine whether an error has occurred in an electronic control circuit by comparing the current pattern data with reference data, and based on the determination, send a control signal to the vehicle for normalizing functions of the electronic control circuit.

The system, wherein the apparatus may comprise, a domain control circuit configured to send, via a wireless communication network, the current pattern data to the server.

The system, wherein the apparatus may comprise, a central communication circuit configured to reset, based on the control signal from the server, the electronic control circuit.

The system, wherein the apparatus may comprise, a power control circuit configured to control, based on at least one of the control signal from the server or a reset request signal from the apparatus, power supplied to the electronic control circuit.

The system, wherein the apparatus may comprise, a central communication circuit configured to control, based on the control signal from the server, an update of a software of the electronic control circuit.

The system, wherein the apparatus may comprise a central communication circuit configured to, generate, information of at least one electronic control circuit, that has sent a wake-up message to the network, time information indicating a time at which the network has woken up, and wake-up information may comprise the current pattern data, and send, based on a preset condition, the wake-up information to the server.

The system, wherein the reference data may comprise current pattern data for each electronic control circuit, that has initially woken up in the network.

The system, wherein the server is further configured to determine that the error has occurred in the electronic control circuit based on a number of times the electronic control circuit wakes up exceeding a preset threshold within a preset time period.

According to the present disclosure, a method performed by an apparatus, the method may comprise, generating current pattern data, based on a transition of a network to a wake-up mode and based on a monitored current consumption amount of a battery over time, wherein the network is connected to at least one of a plurality of electronic control circuits, and wherein the battery supplies power to the network, storing the current pattern data, generating wake-up information may comprise the current pattern data, sending, based on a preset condition, the wake-up information to a server, and adjusting, based on a control signal from the server, an operation of an electronic control circuit.

The method may further comprise, receiving, from the server, the control signal, wherein the control signal is based on a determination of which electronic control circuit, has initially woken up and whether an error has occurred in the electronic control circuit, wherein the adjusting the operation of the electronic control circuit may comprise adjusting a wake-up behavior of the electronic control circuit.

The method may further comprise generating, information of at least one electronic control circuit, that has sent a wake-up message to the network, and time information indicating a time at which the network has woken up.

The method may further comprise, resetting, based on the control signal, the electronic control circuit.

The method may further comprise, updating, based on the control signal, a software of the electronic control circuit.

According to the present disclosure, a method performed by an apparatus, the method may comprise, obtaining data indicative of power consumption of a network over time during a transition of the network to a wake-up state, generating, based on the obtained data, power consumption patterns of the network, transmitting, to a server, the power consumption patterns and identifiers of one or more devices, that have woken up in the network, receiving, from the server, a control signal, wherein the control signal is associated with the power consumption patterns and the identifiers, and adjusting, based on the control signal, an operation of at least one device that have woken up.

The method, wherein the generating the power consumption patterns may comprise generating one or more graphs representing power consumption of the network over time.

The method, wherein the transmitting the power consumption patterns and the identifiers may comprise sending the power consumption patterns and the identifiers to the server before transitioning the network from the wake-up state to a sleep state.

The method, wherein the control signal indicates a reset of the at least one device.

The method, wherein the control signal indicates a software update of the at least one device using an over-the-air update.

The method may further comprise, receiving, from the server, a result of a comparison between the power consumption patterns and reference patterns previously stored for respective devices.

The method, wherein performing the adjusting of the operation of the at least one device is based on a number of times the at least one device wakes up exceeding a threshold number of times within a preset time period.

Effects according to the examples of the present specification are not limited to the description exemplified above, and more various effects are included in the present specification.

### BRIEF DESCRIPTION OF THE DRAWINGS

FIG. 1 shows an example of a management system for an electronic control unit in a vehicle according to an example of the present specification.

FIG. 2 shows an example of a configuration of a network of a management system for an electronic control unit in a vehicle according to an example of the present specification.

FIG. 3 shows an example of an operation method of a network of one group among networks in a vehicle of FIG. 2.

FIG. 4 shows an example of a configuration of a server of the management system for an electronic control unit according to an example of the present specification.

FIG. 5 shows an example of current pattern data of the management system for an electronic control unit according to an example of the present specification.

FIG. 6 shows an example of control of a vehicle of the management system for an electronic control unit according to an example of the present specification.

FIG. 7 shows an example of control of the management system for an electronic control unit according to an example of the present specification.

### DETAILED DESCRIPTION

Hereinafter, the present disclosure is described using examples for specific description, and is described in detail with reference to attached drawings to help understanding of the disclosure. In describing examples disclosed in the present specification, in a case where it is determined that specific description of the known related art may cloud the gist of examples disclosed in the present specification, the detailed description is omitted. In addition, the attached drawings are merely intended to help easy understanding of examples disclosed in the present specification, and do not limit the technical ideas disclosed in the present specification, and it should be understood that the present disclosure includes all modifications, equivalents, and replacements included on the idea and technical scope of the present disclosure.

Terms including ordinals such as “first”, “second”, and the like may be used to describe various elements, but the elements are not limited by the terms. The terms are used only for distinguishing one element from another element.

When it is mentioned that an element is “connected” or “linked” to another element, it should be understood that the element may be directly connected or linked to another element, but another element may exist in between. On the contrary, when it is mentioned that an element is “directly connected” or “directly linked” to another element, it should be understood that another element may not exist in between.

Singular expressions include plural expressions, unless the context clearly indicates otherwise.

In the present application, it should be understood that the term “include” or “have” indicates that a feature, a number, a step, an operation, a component, a part, or a combination thereof described in the specification exists, but does not exclude the possibility of existence or addition of one or more other features, numbers, steps, operations, components, parts, or combinations thereof in advance.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

According to an example of the present specification, it is possible to determine whether an ECU that abnormally wakes up is present or not in a vehicle by sending wake-up data including a current pattern representing a change in a current consumption amount at a time of wake-up in the vehicle to a server via a wireless communication network, determining an ECU that has initially woken up according to the received current pattern in the server, and accumulatively managing a number of times of initial wake-up of the ECU (e.g., counting daily, weekly, or hourly wake-up events, etc.). When it is determined that an error has occurred in the ECU, it is possible to prevent a battery of the vehicle from being dead, depleted, or nonfunctional due to an error in which the ECU abnormally wakes up by sensing a reset order to the ECU from the server or updating a software (e.g., ECU software) using an over-the-air (OTA) service and restoring or normalizing operational functions of the ECU (e.g., resetting communication settings, clearing wake-up triggers, or adjusting sleep mode thresholds, etc.).

Hereinafter, examples disclosed in the present specification are described in detail with reference to attached drawings.

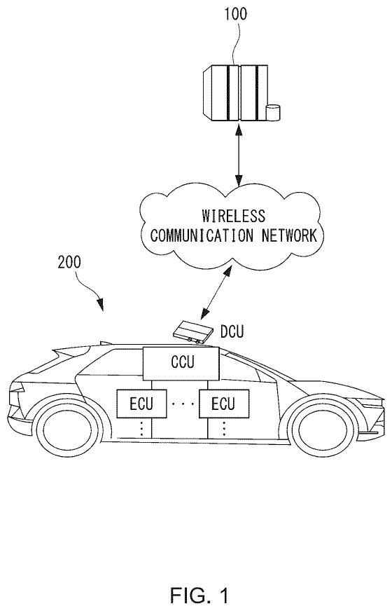

FIG. 1 shows an example of a management system for an electronic control unit in a vehicle according to an example of the present specification (e.g., showing interactions between the CCU, DCU, battery sensor, and server, etc.).

Referring to FIG. 1, the management system for an electronic control unit according to an example of the present specification may include a vehicle (200) including one or more electronic control units (e.g., a powertrain controller, a body controller, an infotainment controller, or a sensor hub controller, etc.) (hereinafter, referred to as ECUs), a domain control unit (DCU) for sending and receiving data via a wireless communication network, and a central communication unit (hereinafter, referred to as CCU) that monitors a state of a vehicle network including one or more of ECUs and DCUs, generates wake-up data when a network in the vehicle is switched from a sleep mode to a wake-up mode, and sends the wake-up data via the DCU, and a server (100) that manages errors associated with the ECU of the vehicle (200) based on the wake-up data received from the vehicle (200).

The vehicle (200) may include a low-voltage battery for starting and operating various electrical devices. The low-voltage battery may play a role as an entrance switch for activating a high-voltage battery at an initial stage, and may provide power to an electrical device, a device for convenient functions, and the like. Such a vehicle (200) may include ECUs to control electronic devices (e.g., motors, lights, cameras, or infotainment systems, etc.). For efficiency of battery power consumption, the ECUs enter a sleep mode if a network communication is not necessary, and may wake up if the network communication is necessary. At the time of wake-up, an ECU may send a network management message (hereinafter, an NM message). If the network is switched from the sleep mode to the wake-up mode, the CCU may store data of the ECU that has sent timestamp information (e.g., including a present time) and an NM message and wake-up data including a current pattern representing a change in a current consumption amount at the time of wake-up. If a set condition is satisfied, the CCU may transmit the wake-up data to the server (100) via the DCU.

The server (100) may determine whether an ECU that abnormally wakes up is present or not based on the wake-up data received from the vehicle (200). The server (100) may determine whether an ECU in which an error of an abnormal wake-up has occurred is present or not in the vehicle (200) by comparing the current pattern data of the wake-up data with standard current pattern data (e.g., reference power usage patterns associated with known-good wake-up sequences, controller-specific load profiles, or time-synchronized current curves, etc.) stored in advance. If it is determined that an error has occurred in the ECU, the server (100) may send a reset order to the ECU or update its a software using an over-the-air (OTA) service (e.g., to correct faulty wake-up behavior, address firmware bugs, or apply updated power management logic, etc.). Such a server (100) may be realized in an extended form obtained by adding functions of wireless software update and vehicle network management service using the OTA to a system of a telematics center providing a remote diagnosis/control service for safe and efficient use of the vehicle (200) sold to a customer (e.g., through cloud-based infrastructure integrated with customer support platforms, vehicle OEM portals, or dealership service tools, etc.). Here, the examples of the present disclosure are not limited thereto. For example, alternatively, the server (100) may be realized as an independent OTA server for the vehicle network management service.

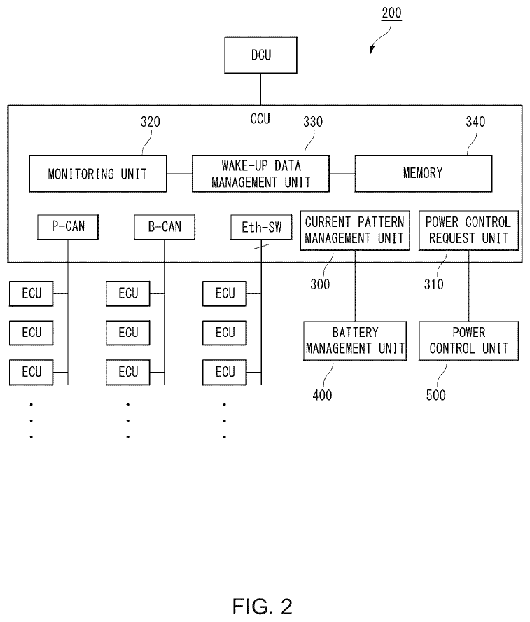

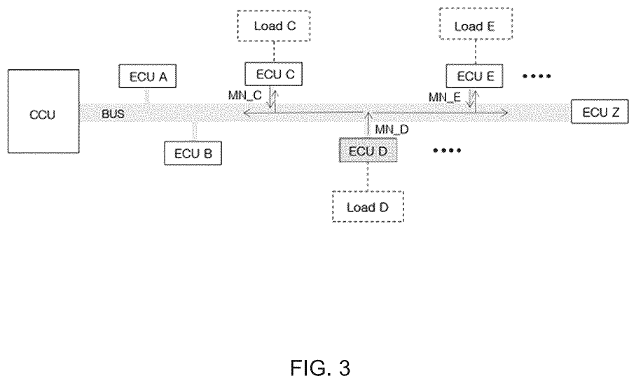

A configuration of the vehicle (200) according to an example of the present specification is described in detail, referring to FIGS. 2 and 3. FIG. 2 shows an example of a configuration of a network in a vehicle (e.g., showing connections among controllers, sensors, and communication modules, etc.), and FIG. 3 shows an example of an operation method of a network of one group among networks in the vehicle of FIG. 2 (e.g., how ECUs exchange NM messages and transition between sleep and wake-up states, etc.).

Referring to FIG. 2, the vehicle (200) may include one or more controllers (e.g., ECUs such as a body controller, a powertrain controller, a chassis controller, or a multimedia controller, etc.), a DCU, a battery management unit (400), a power control unit (500), and a CCU that communicates with each of these elements.

The DCU may include a wireless communication modem that supports external communication of the vehicle (200). The DCU may connect wireless communication between the CCU and the server (100). The DCU may support at least one of common mobile communication (for example, 4G, 5G, or LTE, etc.) and vehicle-to-everything (V2X) communication, but is not limited thereto, and may support advanced forms of wireless technology developed to be applicable to the vehicle (200). The DCU may send wake-up data to the server (100) according to a request of the CCU, and deliver data received from the server (100) to the CCU.

The battery management unit (400) may acquire state data related to the battery and deliver the data to the CCU. Here, the battery may be a low-voltage battery that supplies an operation power source to electrical parts (e.g., controllers, sensors, relays, or actuators, etc.). The battery management unit (400) may send battery information including a state of charge (SoC) of the battery. In addition, the battery management unit (400) may provide data on a change in a current consumption amount at a time of wake-up according to a request of the CCU. Such a battery management unit (400) may include a plurality of sensors that collect data related to a state of the battery such as an output voltage, an input/output current, a temperature, and the like of the battery (e.g., internal resistance, ambient conditions, or charging/discharging rate, etc.). The battery management unit (400) may include a management processor that calculates a state of charge (SoC) of a battery, a state of health (SoH) of the battery, and the like based on the data of the battery state collected from the sensors (e.g., for estimating remaining runtime, triggering protection logic, or adjusting power distribution, etc.).

The power control unit (500) may control a power source supplied to each element in the vehicle. The power control unit (500) may identify at least one ECU among a plurality of ECUs, according to a control signal received from the CCU, and reset the ECU (e.g., a malfunctioning body controller, an unresponsive gateway ECU, or an ECU causing repeated wake-ups, etc.). The power control unit (500) may reset the ECU by shutting off a power source which is a reset target and then re-supplying the power (e.g., by cycling a relay, issuing a low-level hardware reset, or toggling a power domain, etc.). In addition or alternative, if the SoC of the battery is decreased to a standard value or less, the power control unit (500) may shut off a power source supplied to the ECUs to secure a minimum starting voltage (e.g., to prioritize ignition startup, emergency communication, or immobilizer power, etc.). Such a power control unit (500) may include a power control device (e.g., a body domain controller (BDC), a power domain controller (PDC), or a central gateway controller, etc.).

The ECUs may control electronic devices in the vehicle. The electronic devices in the vehicle may include electronic devices or systems that perform various functions such as a traveling function, a convenience function, and a safety function (e.g., propulsion control, climate control, or collision avoidance, etc.). The ECUs may control each of the electronic devices, and send and receive data to and from other ECUs over the vehicle network. The ECUs may use different networks such as a controller area network (CAN), an Ethernet, and a local interconnect network (LIN) (e.g., CAN for powertrain communication, Ethernet for high-speed ADAS data, or LIN for interior lighting control, etc.). The ECUs may be grouped based on the same attributes or similar attributes, the same purpose or similar purpose, and the same installation position or similar position (e.g., front zone, cabin zone, or rear zone, etc.). If network communication is not necessary, The ECUs may enter a sleep mode. A controller (e.g., an ECU) may send a network management message (NM message) at the time of wake-up. The NM message may include identification information of the ECUs that have transmitted the message. A method of transmitting an NM message of an ECU will be described more specifically later.

The CCU may monitor presence or absence of sleep or non-sleep of the controller (e.g., ECU). If the network to which the controllers are connected is switched from a sleep mode to a wake-up mode, the CCU may store data of a controller that has sent time information (e.g., including a present time) and an NM message and wake-up data including a current pattern representing a change in a current consumption amount at the time of wake-up. After that, the CCU may transmit wake-up data to the server (100) according to a preset condition. In addition, the CCU may deliver an ECU reset signal received from the server (100) to the power control unit (500). The CCU may control the ECU to update its a software, according to a software update signal received from the server (100).

Such a CCU may include a plurality of communication modules (P-CAN, C-CAN, Eth-SW), a current pattern management unit (300), a power control request unit (310), a monitoring unit (320), a wake-up data management unit (330), and a memory (340).

One or more of controllers (e.g., ECUs) may be connected to each of the communication modules (e.g., P-CAN, B-CAN, Eth-SW, etc.). The controllers connected to the each of the communication modules may be grouped by an installation area of an electronic device controlled by the controllers (e.g., front cabin, center console, or rear zone, etc.), or may be grouped by an electronic device that performs the similar function or the same function (e.g., lighting, infotainment, safety systems, or climate control, etc.). Each of the communication modules (P-CAN, B-CAN, Eth-SW) may transmit a control signal to each ECU via a wired communication BUS, and may receive a state signal of the electronic device from each ECU. Each of the communication modules (P-CAN, B-CAN, Eth-SW) may include a module that performs different CAN communications, an Ethernet switch (Eth-SW), and the like. The module that performs CAN communication may include:
a multimedia controller area network (M-CAN) communication module for communication with an audio device, a radio device, an audio-video-navigation (AVN) device, or rear-seat entertainment systems, etc.;
a body controller area network (B-CAN) communication module that sends and receives a signal to operate various electronic devices such as interior lighting, a cluster, a door lock device, a lamp, a wiper, seats, a sheet, a heater, or mirrors, etc.;
a power train controller area network (P-CAN) communication module that sends and receives a signal for controlling a power train, stability control (ABS, TCU, TPMS, active suspension, and the like), or transmission function, etc.;
a chassis controller area network (C-CAN) communication module for controlling an electronic parking brake (EPB), steering systems, or damping control, etc.,
a diagnostic controller area network (D-CAN) communication module for diagnosing errors, or maintenance diagnostics, etc.

The Ethernet switch (Eth-SW) may be connected to a controller (e.g., an ECU) for control of autonomous driving functions, autonomous parking systems, or ADAS features (e.g., lane keep assist, collision avoidance, or remote parking, etc.). In addition to these, various communication modules may be provided in the CCU, for example, depending on vehicle model or architecture.

The current pattern management unit (300) may receive current consumption amount data from the battery management unit (400) and store the received data. For example, the current pattern management unit (300) may send and receive data to and from the battery management unit (400) via a local interconnect network (LIN) communication method. The current pattern management unit (300) may convert the current consumption amount data to current pattern data in a form of a time series graph according to a request of the wake-up data management unit (330).

The power control request unit (310) may request the power control unit (500) to control a power source of a specific controller (e.g., ECU). The power control request unit (310) may request the power control unit (500) to reset the controller, according to an ECU reset signal received from the server (100).

The monitoring unit (320) may monitor a sleep or non-sleep state of the controller according to a state signal of the controller received via the communication modules (e.g., P-CAN, B-CAN, Eth-SW, etc.). The monitoring unit (320) may monitor whether a non-sleep ECU is present or not for a predetermined time after the vehicle (200) is turned off. For example, after the vehicle is turned off, the monitoring unit (320) may receive a state signal of an ECU via the communication modules (e.g., P-CAN, B-CAN, Eth-SW, etc.) for 40 minutes and determine whether any non-sleep ECU is present or not. When any non-sleep ECU is not present for 40 minutes, the CCU may also enter a sleep mode and be maintained in a standby state, for example, for monitoring only. In a case where a non-sleep ECU is present, the monitoring unit (320) may store data of the non-sleep ECU and may also store cause information from the non-sleep ECU regarding why the non-sleep ECU failed to enter sleep mode. After that, if the SOC of the battery is decreased to a standard value or less, the power control unit (500) may shut off a power source to secure a minimum starting voltage (e.g., 12.0 V for cold cranking, 11.5 V for system boot, or as defined by vehicle startup thresholds, etc.). If an NM message notifying wake-up is received from the ECU in a sleep state, the monitoring unit (320) according to an example of the present specification may deliver a wake-up signal to the wake-up data management unit (330) (e.g., to initiate logging, trigger current profiling, or activate diagnostic tracking, etc.).

If the wake-up signal is received from the monitoring unit (320), the wake-up data management unit (330) may store data of the ECU that has sent time information (e.g., a timestamp including a present time) and an NM message in the memory (340) (e.g., ECU ID, time of wake-up, and NM message content, etc.). If the wake-up signal is received from the monitoring unit (320), the wake-up data management unit (330) may request the current pattern management unit (300) to generate current pattern data (e.g., a graph showing current rise time, peak draw, and stabilization phase, etc.). The current pattern data may be in a form of graph showing power usage trends over time (e.g., a change in the current consumption amount over time), and may further include information that may have influence on the current pattern (e.g., battery temperature information, ambient temperature, or battery aging status, etc.). The wake-up data management unit (330) may store the current pattern data and the data of ECU that has sent a present time and an NM message as wake-up data.

The wake-up data management unit (330) may send wake-up information to the server (100) via a DCU if a preset condition is satisfied. For example, various sending conditions may be set such that the wake-up data management unit (330) may send the information according to a preset sending period (e.g., every 6 hours, once per day, or every ignition cycle, etc.), send the information immediately before the CCU is switched to a sleep mode, or send information if wake-up information is collected a preset number of times or more (e.g., 3 times, 5 times, or 10 times, etc.).

FIG. 3 is a view illustrating operation of a network of one group among networks in the vehicle of FIG. 2, and a view for describing a method of sending an NM message from an ECU.

Referring to FIG. 3, the ECUs in the vehicle may be connected to one network depending on a function or role (e.g., infotainment control, powertrain control, chassis control, or body electronics, etc.). For example, ECU A to ECU Z may be connected to one communication BUS. If all of the ECU A to ECU Z enter a sleep mode, the CCU is also switched to a sleep mode.

If the ECU D wakes up, the ECU D sends an NM message (NM_D). The NM message (NM_D) of the ECU D is delivered to other ECUs via a BUS and all the ECUs (ECU A to ECU Z) connected to the same BUS subsequently wake up. Here, depending on factors such as a length of a wire, node location, electromagnetic interference, or circuit properties of each ECU, etc., a time difference may occur at a time of or during the wake-up of the ECUs (ECU A to ECU Z). For example, in a case where the ECU D has initially woken up, each of the ECU C and the ECU E at the most adjacent position receive an NM message (NM_D) to wake up. Therefore, at a time when the CCU receives the NM message to wake up, a plurality of ECUs is already in a wake-up state, and the CCU may receive NM messages (NM_C, NM_D, NM_E) transmitted by the ECU C, ECU D, ECU E, or other neighboring ECUs, etc., which have woken up first. Therefore, it is difficult for the CCU to determine which ECU has initially woken up via the NM message or based solely on the NM message.

As the ECUs wake up sequentially, a corresponding load of each of the ECUs is booted and a current is consumed. Therefore, the current consumption amount gradually increases after the ECU has initially woken up. Topology such as a wire connection structure, wiring layout, a connection distance, or node branching structure, etc. for each controller of each vehicle is fixed, and circuit properties for each ECU are uniform. Therefore, it can be said that, when a specific ECU initially wakes up, a wake-up order of each ECU and a booting order of a load are consistently uniform, and as a result, it can be said that the current consumption pattern triggered by the initially waking ECU is also uniform(e.g., a gradual current rise as each dependent module boots, followed by a plateau once the network stabilizes, etc.). With this, in examples of the present specification, a current pattern consumed when each ECU has initially woken up in a particular vehicle type is acquired in advance and stored in the server (100), and an ECU that has initially woken up can be determined by receiving a current pattern at a time of wake-up from the vehicle (200) of a customer from the server (100).

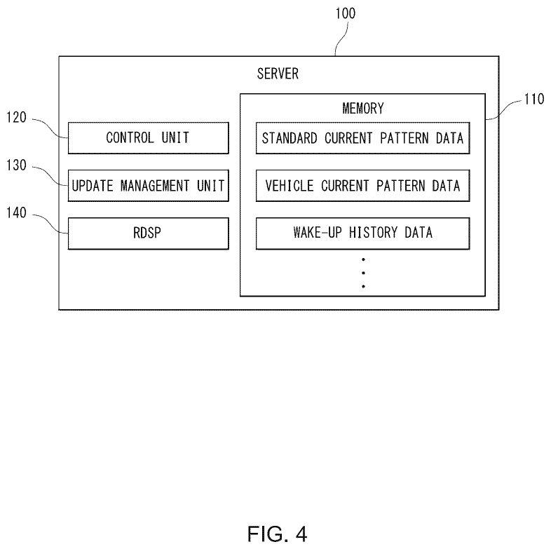

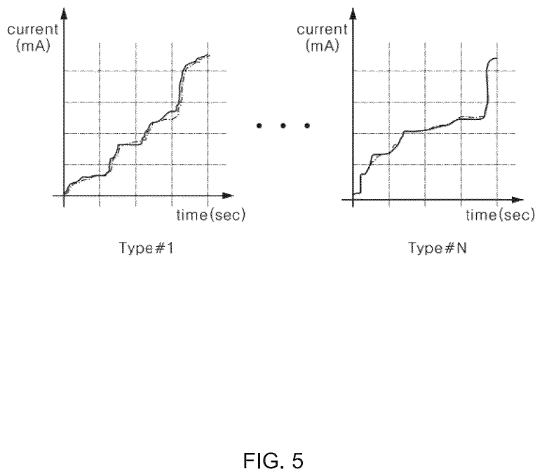

FIG. 4 shows an example of a configuration of the server (100) of a management system for an electronic control unit in a vehicle according to an example of the present specification (e.g., showing functional modules such as memory, control logic, update handler, and remote diagnostics platform, etc.). FIG. 5 shows an example of current pattern data of the management system for an electronic control unit according to an example of the present specification (e.g., power usage curves for different ECU wake-up scenarios, such as remote start, key-on, or sensor-triggered events, etc.).

Referring to FIG. 4, the server (100) may include a memory (110), a control unit (120), an update management unit (130), and a remote diagnosis service platform (RDSP) (140) (e.g., implemented on a centralized backend cloud, distributed gateway nodes, or hybrid edge-compute architecture, etc.).

The memory (110) may store standard current pattern data, vehicle current pattern data, wake-up history data, and the like. The standard current pattern data may include a current pattern consumed when each ECU has initially woken up in a vehicle (e.g., a specific vehicle type). The current consumption pattern according to the ECU that has initially woken up may be obtained by experimenting or simulating a current pattern consumed when each ECU has initially woken up, such as a case where the ECU A has initially woken up in a development stage of the vehicle, a case where the ECU B has initially woken up, and a case where the ECU C has initially woken up (e.g., under varying temperature or load conditions, etc.). FIG. 5 shows an example of a standard current pattern data stored in the memory (110). Referring to FIG. 5, the standard current pattern data may be in a form of graph showing time-dependent variations in power consumption (e.g., change in the current consumption amount over time). The standard current pattern data may be stored as Type #1 to Type #N according to the kind of the vehicle and the ECU that has initially woken up (e.g., a compact EV with a telematics ECU, a hybrid SUV with a gateway ECU, or a luxury sedan with a multimedia ECU, etc.). The standard current pattern data may further include information that has an influence on a current pattern, for example, battery temperature information (e.g., measured in cold-start vs. hot-soak conditions, or based on ambient temperature profiles, etc.), and the like. The vehicle current pattern data may include current pattern data received from a customer's vehicle during actual field operation. The wake-up history data may include data identifying the ECU that has initially woken up for each vehicle recorded over time.

If a new version software or a new software is registered, the update management unit (130) may install the new version software in the vehicle by an OTA method. In addition, the update management unit (130) may reinstall the software of the ECU or update the new version software if there is a request of the control unit (120).

The RDSP (140) may remotely perform a diagnosis of the ECU in a vehicle. The RDSP (140) may remotely diagnoses a state of the ECU if there is a request of the control unit (120). The RDSP (140) may remotely repair or reset the ECU according to the remote diagnosis result (e.g., by issuing a reset command or initiating software recovery, etc.).

The control unit (120) may receive wake-up data from the vehicle (200) and store the received data in the memory (110). The control unit (120) may determine the ECU that has initially woken up by comparing the vehicle current pattern data received from the vehicle (200) with the standard current pattern data. The control unit (120) may store data of the ECU that has initially woken up in a particular vehicle type as wake-up history data and store thereof. The control unit (120) may determine an ECU is in an abnormal state if it has woken up more than a threshold number of times within a predetermined period (e.g., 5 times in 24 hours, 10 times in 3 days, etc.). When an ECU that abnormally wakes up is checked, the control unit (120) provides the RDSP (140) with information of the ECU and proceeds remote diagnosis.

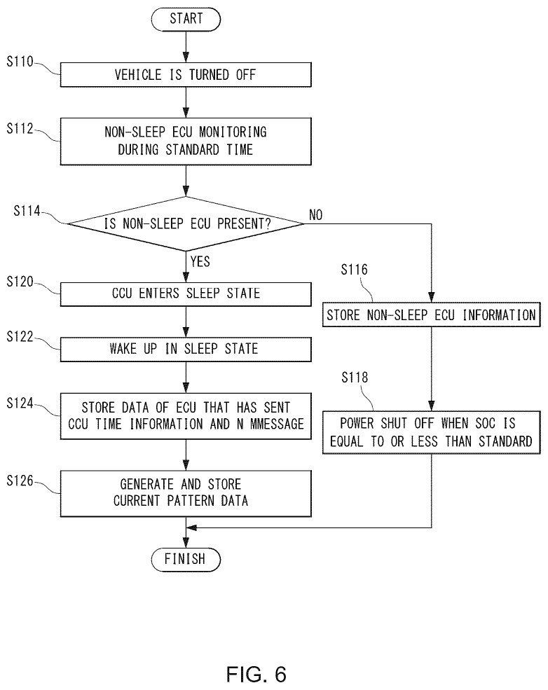

FIG. 6 shows an example of control of a vehicle according to an example of the present specification (e.g., sleep state monitoring, wake-up processing, or power cutoff logic, etc.).

The CCU of the vehicle (200) may monitor whether a non-sleep ECU is present or not for a predetermined time after the vehicle is turned off (S110, S112). For example, the CCU may monitor whether a non-sleep ECU is present for approximately 40 minutes after the vehicle is turned off.

The CCU determines whether a non-sleep ECU is present for a standard monitoring time (S114), and, if such a non-sleep ECU is present, may collect data on an operating state of the non-sleep ECU (S116). The CCU may ask a reason for non-sleep to the non-sleep ECU, receive a response, and store the response data, for example, for further analysis.

After that, if the state of charge (SOC) is decreased to a standard value or less, the CCU may shut off a power source to secure a minimum starting voltage (S118).

If no non-sleep ECU is present, as determined in (S114), the CCU may also enter a sleep mode (S120). In the sleep mode, the CCU may maintain a standby state while performing only essential functions (e.g., a monitoring function).

In the sleep state, the CCU may wake up by receiving a wake-up network management (NM message) (S122) (e.g., a message initiated by a peripheral controller, gateway unit, or smart key activation, etc.).

In the sleep state, the CCU that has woken up stores data of the ECU that has sent present time information (e.g., a timestamp) and the NM message (S124). At this time, a plurality of ECUs among the ECUs connected to the BUS may already be awake and transmitting the NM message. The CCU may store data of the plurality of ECUs (e.g., ECU B, ECU D, or ECU F, etc.) that have sent the NM messages received at the time of wake-up or during the wake-up sequence.

The CCU may request the current consumption amount data to the battery management unit (400), and generate current pattern data, and then store the resulting data (S126). Through this process, the CCU may store wake-up data including data of the ECU that has sent a wake-up time and the NM message and the current pattern data (e.g., a rising current slope, peak load time, or current drop-off rate, etc.).

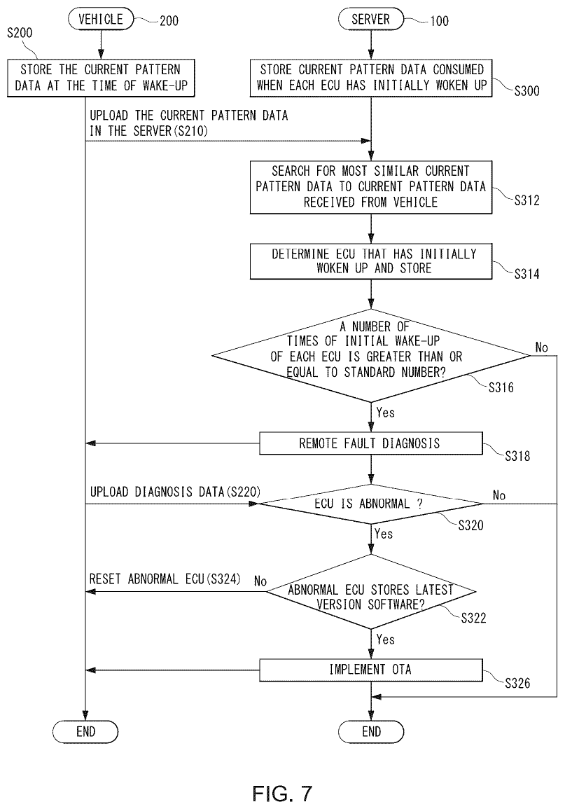

FIG. 7 shows an example of control of the management system for an electronic control unit according to an example of the present specification (e.g., data collection, pattern comparison, and remote diagnostics, etc.).

As described with reference to FIG. 6, the vehicle (200) may store the current pattern data at the time of wake-up while in the sleep mode (S200).

After that, the vehicle (200) may upload the current pattern data in the server (100) during a preset period (S210). Here, the current pattern data may be stored as wake-up data along with the data of the ECU that has sent the wake-up time (e.g., a timestamp) and the NM message (e.g., ECU X sent NM at 3:47 AM, current peaked at 2.3 A, etc.).

The server (100) stores the current pattern data consumed when each ECU has initially woken up in a particular vehicle type (S300). The current pattern data stored in the server (100) may be obtained by experimenting or simulating a current pattern consumed when each ECU has initially woken up in a development stage of the vehicle (e.g., test scenarios involving cold start, accessory activation, or remote key fob triggers, etc.).

The server (100) searches the most similar current pattern data by comparing the current pattern data received from the vehicle (200) with the current pattern data stored in advance (S312), and, according to the search result, determines the ECU that has initially woken up and stores identification result (S314).

The server (100) checks whether a number of times of initial wake-up of the ECU satisfies (e.g., meets or exceeds) the standard number of times (e.g., a predefined threshold) or more (S316). The server (100) may determine that the ECU is in an abnormal state if it has woken up the standard number of times or more during a preset period (e.g., more than 5 times in 24 hours, or more than 10 times in 3 days, etc.).

The server (100) diagnoses whether the ECU is at fault or not, when it is checked that the ECU has woken up the standard number of times or more (S318). This may include fault logic such as checking for NM conflicts, bus voltage abnormalities, or firmware bugs, etc.

The vehicle (200) may generate diagnosis data according to a request of remote fault diagnosis of the server (100) and upload the diagnosis data in the server (100) (S220).

The server (100) receives the diagnosis data from the vehicle (200) and determines whether the ECU exhibits abnormal behavior (S320). This determination may be based on criteria such as communication failure codes, excessive wake-up frequency, or inconsistent power draw patterns, etc.

If it is determined that the ECU has abnormality, the server (100) determines whether the ECU stores a latest version software or not (S322) (e.g., version 3.2.1 or higher for compatibility with the updated diagnostic protocol, etc.).

In a case where the latest version software of the ECU is not stored, the server (100) sends a reset signal to the ECU (S324). The vehicle (200) may reset the ECU according to the ECU reset signal of the server (100) and recover from an error state (e.g., by cycling power, reinitializing memory, or clearing transient faults, etc.).

In a case where the latest version software of the ECU is stored, the server (100) updates the software of the ECU of the vehicle (200) using an OTA function (S326) (e.g., applying a patch to resolve improper sleep transitions or NM message misbehavior, etc.).

As described above, according to an example of the present specification, it is possible to determine whether an ECU that abnormally wakes up is present in a vehicle by sending wake-up data including a current pattern representing a change in a current consumption amount at a time of wake-up in the vehicle to the server (100) via a wireless communication network. The server (100) may determine which ECU has initially woken up based on the received current pattern in the server (100), and accumulatively managing (e.g., logging or tracking) a number of times that ECU initiates wake-ups. If it is determined that an error has occurred in the ECU, it is possible to prevent a battery of the vehicle from becoming depleted due to repeated abnormal wake-ups by either sending a reset order to the ECU by the server (100), or updating a software (e.g., ECU controlling software) using an over-the-air (OTA) service to normalize the ECU's functionality (e.g., restoring expected sleep intervals, preventing unnecessary bus activity, or disabling faulty logic paths, etc.).

A management system for an electronic control unit in a vehicle according to an example of the present specification includes a server configured to determine an error of an electronic control unit (ECU) in the vehicle by comparing current pattern data received from the vehicle with standard data stored in advance, and, based on the error, send a control signal for normalizing functions of the ECU; and a central communication unit configured to, in a case where a network to which at least one or more of ECUs are connected is switched to a wake-up mode, convert a current consumption amount of a battery of supplying power to the network into the current pattern data and send the current pattern data to the server.

The management system for an electronic control unit in a vehicle according to an example of the present disclosure may further include a domain control unit (DCU) configured to send the current pattern data to the server via a wireless communication network.

The central communication unit may reset the ECU, according to the control signal.

The management system for an electronic control unit in a vehicle according to an example of the present disclosure may further include a power control unit configured to control power applied to the ECU, according to a reset request of the central communication unit.

The central communication unit may control a software of the ECU to be updated, according to the control signal received from the server.

The central communication unit generates information of at least one ECU that has sent a wake-up message to the network, information of time at which the network has woken up, and a wake-up information including the current pattern data, and may send the wake-up information to the server according to a preset condition.

The standard data may include current pattern data for each ECU that has initially woken up, in the network to which at least one or more of ECUs are connected.

The server may determine that an error has occurred in the ECU based on a preset number of times of initial wake-ups of the ECU within a preset time period.

A management method for an electronic control unit in a vehicle according to an example of the present specification includes a step of, when a network to which at least one or more of ECUs are connected in the vehicle is switched to a wake-up mode, converting a current consumption amount of a battery of supplying power to the network into current pattern data and storing the current pattern data; a step of generating information of at least one ECU that has sent a wake-up message to the network, information of time at which the network has woken up, and a wake-up information including the current pattern data; and a step of sending the wake-up information to a server according to a preset condition.

The management method for an electronic control unit in a vehicle according to an example of the present specification may further include a step of storing standard data including current pattern data for each ECU that has initially woken up in advance, in the network to which the at least one or more of ECUs are connected; a step of receiving the wake-up information from the server, and searching most similar standard data among the current pattern data of the vehicle; a step of determining an ECU that has initially woken up according to the searched standard data; and a step of determining an error of the ECU that has initially woken up, and sending a control signal for normalizing functions of the ECU based on the error.

The step of determining an error of the ECU that has initially woken up may further include a step of determining that an error has occurred in the ECU based on a preset number of times of initial wake-ups of the ECU within a preset period.

The management method for an electronic control unit in a vehicle according to an example of the present specification may further include a step of resetting the ECU of the vehicle, according to the control signal.

The management method for an electronic control unit in a vehicle according to an example of the present specification may further include a step of updating a software of the ECU, according to the control signal.

Examples of the present specification have effects as follows.

Management system and method for an electronic control unit in a vehicle according to an example of the present specification can provide remote repair functions by determining presence or absence of errors of an ECU in a vehicle from a server that manages the vehicle, and resetting the ECU in which an error has occurred or performing software update using an over-the-air (OTA) service.

The management system and method for an electronic control unit in a vehicle according to an example of the present specification can prevent a battery of a vehicle from being dead by an increase in unnecessary dark currents, due to an error in which the ECU abnormally wakes up.

Hereinabove, examples of the present specification have been described in more detail with reference to attached drawings, but the present specification is not necessarily limited to these examples and could be variously modified within a range not departing from the technical idea of the present specification. Therefore, the examples disclosed in the present specification are not to limit the technical idea of the present specification but to describe thereof, and these examples do not limit the range of the technical idea of the present specification. Therefore, the examples described above should be understood as exemplary and not limited. The protection scope of the present specification should be construed by the scope of claims, and all technical ideas within the equivalent range should be construed to be included in the scope of the present specification.

What is claimed:

1. A system comprising:
an apparatus, of a vehicle, configured to:
generate current pattern data, based on a transition of a network to a wake-up mode and based on a monitored current consumption amount of a battery over time, wherein the network is connected to at least one of a plurality of electronic control circuits of the vehicle, and wherein the battery supplies power to the network; and
a server configured to:
receive, from the vehicle, the current pattern data,
determine whether an error has occurred in an electronic control circuit among the plurality of electronic control circuits of the vehicle by comparing the current pattern data with reference data, and
based on the determination, send a control signal to the vehicle for normalizing functions of the electronic control circuit.

2. The system according to claim 1, wherein the apparatus comprises:
a domain control circuit configured to send, via a wireless communication network, the current pattern data to the server.

3. The system according to claim 1, wherein the apparatus comprises:
a central communication circuit configured to reset, based on the control signal from the server, the electronic control circuit.

4. The system according to claim 1, wherein the apparatus comprises:
a power control circuit configured to control, based on at least one of the control signal from the server or a reset request signal from the apparatus, power supplied to the electronic control circuit.

5. The system according to claim 1, wherein the apparatus comprises:
a central communication circuit configured to control, based on the control signal from the server, an update of a software of the electronic control circuit.

6. The system according to claim 1, wherein the apparatus comprises a central communication circuit configured to:
generate:
information of at least one electronic control circuit, among the plurality of electronic control circuits, that has sent a wake-up message to the network,
time information indicating a time at which the network has woken up, and
wake-up information comprising the current pattern data, and
send, based on a preset condition, the wake-up information to the server.

7. The system according to claim 1, wherein the reference data comprises current pattern data for each electronic control circuit, of the plurality of electronic control circuits, that has initially woken up in the network.

8. The system according to claim 7, wherein the server is further configured to determine that the error has occurred in the electronic control circuit based on a number of times the electronic control circuit wakes up exceeding a preset threshold within a preset time period.

9. A method performed by an apparatus of a vehicle, the method comprising:
generating current pattern data, based on a transition of a network to a wake-up mode and based on a monitored current consumption amount of a battery over time, wherein the network is connected to at least one of a plurality of electronic control circuits of the vehicle, and wherein the battery supplies power to the network,
storing the current pattern data;
generating wake-up information comprising the current pattern data;
sending, based on a preset condition, the wake-up information to a server; and
adjusting, based on a control signal from the server, an operation of an electronic control circuit of the plurality of electronic control circuits.

10. The method according to claim 9, further comprising:
receiving, from the server, the control signal, wherein the control signal is based on a determination of which electronic control circuit, among the plurality of electronic control circuits, has initially woken up and whether an error has occurred in the electronic control circuit, wherein the adjusting the operation of the electronic control circuit comprises adjusting a wake-up behavior of the electronic control circuit.

11. The method according to claim 10, further comprising generating:
information of at least one electronic control circuit, among the plurality of electronic control circuits, that has sent a wake-up message to the network, and
time information indicating a time at which the network has woken up.

12. The method according to claim 10, further comprising:
resetting, based on the control signal, the electronic control circuit.

13. The method according to claim 10, further comprising:
updating, based on the control signal, a software of the electronic control circuit.

14. A method performed by an apparatus of a vehicle, the method comprising:
obtaining data indicative of power consumption of a network in the vehicle over time during a transition of the network to a wake-up state;
generating, based on the obtained data, power consumption patterns of the network;
transmitting, to a server, the power consumption patterns and identifiers of one or more devices, of the vehicle, that have woken up in the network;
receiving, from the server, a control signal, wherein the control signal is associated with the power consumption patterns and the identifiers; and
adjusting, based on the control signal, an operation of at least one device of the one or more devices that have woken up.

15. The method of claim 14, wherein the generating the power consumption patterns comprises generating one or more graphs representing power consumption of the network over time.

16. The method of claim 14, wherein the transmitting the power consumption patterns and the identifiers comprises sending the power consumption patterns and the identifiers to the server before transitioning the network from the wake-up state to a sleep state.

17. The method of claim 14, wherein the control signal indicates a reset of the at least one device.

18. The method of claim 14, wherein the control signal indicates a software update of the at least one device using an over-the-air update.

19. The method of claim 14, further comprising:
receiving, from the server, a result of a comparison between the power consumption patterns and reference patterns previously stored for respective devices of the one or more devices.

20. The method of claim 14, wherein performing the adjusting of the operation of the at least one device is based on a number of times the at least one device wakes up exceeding a threshold number of times within a preset time period.
